(19) United States
(12) Patent Application Publication
(10) Pub. No.: US 2015/0055453 A1
(43) Pub. Date: Feb. 26, 2015

(54) DETOUR PATH CALCULATION METHOD IN EMERGENCY

(71) Applicant: HITACHI, LTD., Tokyo (JP)

(72) Inventors: Nobuyuki CHAKI, Tokyo (JP); Yasumichi NONAKA, Tokyo (JP); Akihiro KAMIYA, Tokyo (JP)

(21) Appl. No.: 14/326,871

(22) Filed: Jul. 9, 2014

(30) Foreign Application Priority Data
Aug. 23, 2013 (JP) 2013-173520

(51) Int. Cl. H04L 12/24; H04L 12/751

(52) U.S. Cl. CPC H04L 41/0668; H04L 45/02; H04L 41/12
USPC 370/225

(57) ABSTRACT

A path table, a topology table and a level-of-service agreement table are stored in a storage device of a monitoring control apparatus. A path in which a communication fault occurs is determined based on the path table. The service levels small in terms of an upper limit value of a service cutoff time in emergency are sequentially extracted from the level-of-service agreement table. A path route calculation process is performed on at least one path coincident with the extracted service level, based on the path table. A path route optimization process is performed on at least one path route subjected to the route calculation. An execution result of the path route optimization process is registered in a path calculation result table.

### CLAIM OF PRIORITY

The present application claims priority from Japanese application JP 2013-173520 filed on Aug. 23, 2013, the content of which is hereby incorporated by reference into this application.

### BACKGROUND OF THE INVENTION

The present invention relates to a technology in which in a detour path setting method for a transmission device system, a monitoring control apparatus grasps a resource situation at the occurrence of a fault and calculates a detour path based on a level of service agreement in emergency to thereby perform a path setting.

In general, in a transmission system, 1+1 path protection redundancy is constructed in preparation for service cutoff at the occurrence of a fault. This is a system in which when a fault occurs in an active system path that provides services, a line is switched to a reserve system path to continue services. There may however be a case where at a major fault such as at a serious disaster or the like, a fault simultaneously occurs in both of the active system path and the reserve system path so that the services are cut off. When such a service cutoff has occurred, the calculation and setting of a third route (detour path) are required.

Methods for calculating and setting a detour path are roughly divided into a system for collecting information by a monitoring control apparatus to calculate and set a detour path, and a system for autonomously collecting information by each transmission device through signaling (transfer of control signals, e.g., the action of causing routers to autonomously control paths to one another) to calculate and set a detour path. The system of setting the detour path by the monitoring control apparatus has the merit of being able to shorten a fault recovery time because a route calculation is done earlier than the system of autonomously performing the detour path calculation and setting by each transmission device. Further, while the signaling is limited to an effective range in the system of autonomously performing the settings by the transmission device, the system of performing the settings by the centralized control apparatus has the merit of being able to more efficiently use resources because a detour path straddling a path's layer and an apparatus bender, and a detour path including a legacy device (device operated in an old form) can be calculated and set.

There is known Patent Document 1 (JP-2006-340058-A) as a background art in the present technical field. Described in the present publication is that prompt fault recovery is performed by carrying out fault recovery using a detour route calculated in advance upon multiple faults (refer to Abstract). There is also known Patent Document 2 (JP-2006-174046-A). The publication has described that information that allows a path type at a normal time and a candidate for a path type at bulk transfer given priority to correspond to each other is recorded in a node at which an autonomous detour path route calculation and the setting of a bulk transfer path are possible, and a detour path is route-searched while replacing the path type of the bulk transfer path, based on this information in occurrence of a fault.

### SUMMARY OF THE INVENTION

The above related art is accompanied by a problem that since it is premised on the signaling process between the transmission devices, the application network described previously is limited.

In particular, advance preparations for all faults with respect to all services are not realistic because there is a limitation in a resource. That is, the system of calculating and setting the detour path needs to perform the calculation and setting of a path route according to the occurrence situation of the faults. At the major fault such as at the serious disaster or the like, the relative priority between the lines in normal time and the priority therebetween in emergency should be different from each other because of different uses. Likewise, the line recovery time should also be made different according to the relative priority between the lines.

Thus, the detour path setting system has been required to calculate and set “(2) the detour path corresponding to the resource situation in emergency” “(1) in accordance with the relative priority between the lines in emergency” “(3) with a service cutoff time held in a shorter period of time.”

Since the lines brought to the service cutoff often occur simultaneously at the major fault such as at the serious disaster or the like, the following problems arise.

The first problem is that the resources necessary for the detour paths of all lines may become insufficient because the lines each required to be changed to the detour path often occur simultaneously, and there is a need to adopt or reject selectively the lines to be recovered, according to the relative priority between the lines in emergency.

The second problem is that since the lines required to be changed to the detour paths often occur simultaneously, the time necessary to calculate and set all the detour paths is taken long, so that the recovery of each line to be given priority in emergency is delayed.

The present invention aims to provide a method of calculating and setting a detour path by a monitoring control apparatus.

A monitoring control apparatus for carrying out a detour path calculation method in emergency in the present invention has the following unit.

A unit for determining the following information B so as to satisfy the following conditions A.

Conditions A:

(1) Recovery of each line high in resource securing priority is performed preferentially.

(2) Number of lines satisfying a level of service agreement in emergency is more increased.

The in-emergency level of service agreement includes the following items:
Upper limit value of service cutoff time
Line quality (minimum value of guaranteed band, upper limit values of latency/jitter/packet loss rate)

Information B:
(1) Path route
(2) Setting schedule including period and order

According to the present invention, it is possible to calculate and set detour paths in descending order of the relative priority among lines in emergency. Also, according to the present invention, detour paths can be calculated and set in such a manner that the number of lines each satisfying a level of service agreement in emergency (an upper limit value of a service cutoff time, etc.) is more increased.

### BRIEF DESCRIPTION OF THE DRAWINGS

FIG. 1A is a diagram showing a system configuration at a normal time;

FIG. 1B is a diagram illustrating the system configuration at fault occurrence;

FIG. 2A is a diagram showing pass setting times in a related art;

FIG. 2B is a diagram depicting service agreement information (level-of-service agreement table) held in a monitoring control apparatus;

FIG. 2C is a diagram (excess of an upper limit value at a service cutoff) illustrating pass setting times in the related art;

FIG. 3 is a diagram showing a hardware configuration of the monitoring control apparatus;

FIG. 4 is a diagram showing a software configuration of the monitoring control apparatus;

FIG. 5 is a diagram illustrating data transfer path information (path table) of transmission devices, which are held in the monitoring control apparatus;

FIG. 6 is a diagram showing level-of-service agreement information (level-of-service agreement table) held in the monitoring control apparatus;

FIG. 7 is a diagram depicting link information (topology table) of the transmission devices, which are held in the monitoring control apparatus;

FIG. 8 is a diagram showing information (path calculation result table) of path route calculation results held in the monitoring control apparatus;

FIG. 9 is a diagram illustrating information (path route object-exclusion table) excluded from each route object upon path route calculation, which is held in the monitoring control apparatus;

FIG. 10 is a diagram showing transaction information (path setting transaction table) of path settings held in the monitoring control apparatus;

FIG. 11 is a diagram depicting a sequence for notifying a service cutoff from a transmission device;

FIG. 12 is a diagram showing a sequence for notifying a link fault from a transmission device;

FIG. 13 is a diagram illustrating a sequence for performing the calculation, optimization and settings of a detour path by the monitoring control apparatus;

FIG. 14A is a diagram showing a processing flow of a path route calculation and a path route optimization calculation in the monitoring control apparatus;

FIG. 14B is a diagram illustrating a processing flow of a path route calculation in the monitoring control apparatus;

FIG. 14C is a diagram depicting a processing flow of a path route optimization calculation in the monitoring control apparatus; and

FIG. 15 is a diagram representing path setting times in the present invention.

### DESCRIPTION OF THE PREFERRED EMBODIMENT

The present embodiment will describe an example in which a monitoring control apparatus determines path routes and a setting schedule to satisfy the following conditions.

Condition (1): Recovery of a line high in resource securing priority is performed preferentially.
Condition (2): Number of lines satisfying a level of service agreement in emergency is more increased. The level of service agreement includes an upper limit value of a service cutoff time and line quality (minimum value of a guaranteed band, and upper limit values of a latency/jitter/packet loss rate).

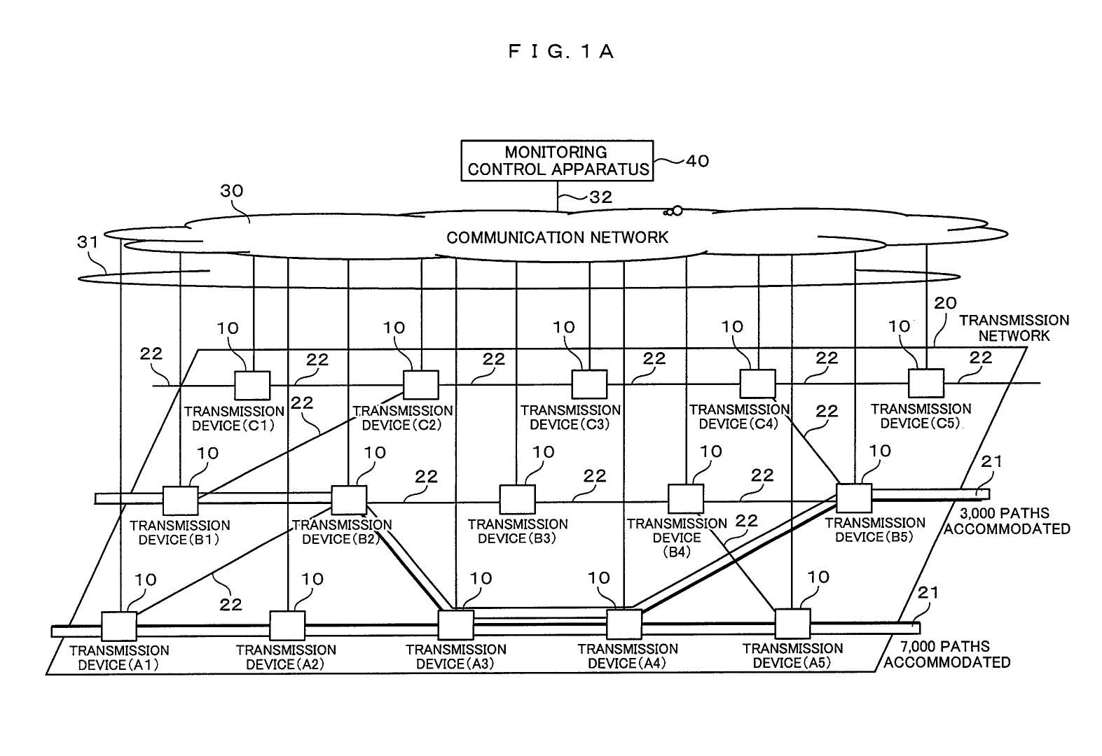

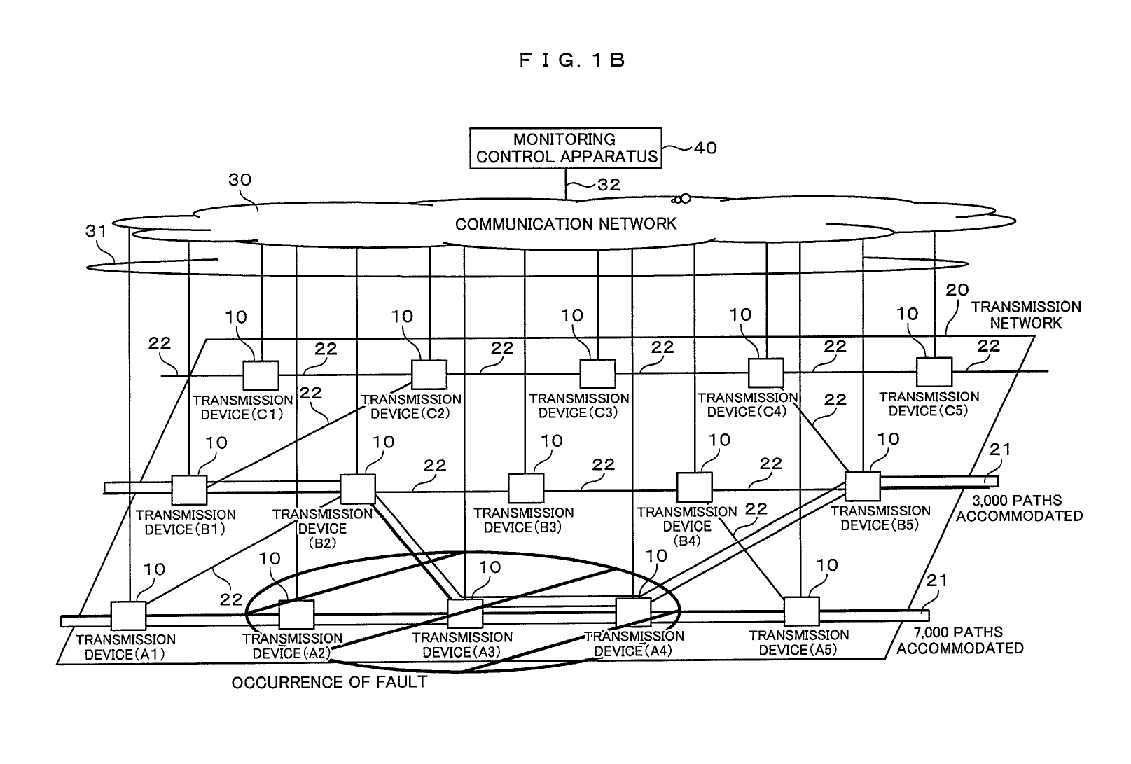

FIG. 1A is a diagram showing a configuration example of a system according to the present embodiment. The present system is composed of transmission devices 10, a transmission network 20, a communication network 30, and a monitoring control apparatus 40. The monitoring control apparatus 40 monitors the operations of a plurality of the transmission devices 10 included in the communication network 30, and the transmission network 20 and controls paths in the communication network 30.

In the description according to the following embodiment, when any of a plurality of transmission devices is typically shown, it is expressed as “transmission device 10.” When a specific transmission device is designated among the plurality of transmission devices, reference symbols attached to individual transmission devices as in the case of a “transmission device A1,” a “transmission device of B1,” etc. are represented.

The transmission devices 10 are connected to each other by data transfer lines (links) 22 in the transmission network 20. A route of each line to which user data is transferred is referred to as a data transfer route (path) 21. In the present embodiment, there is shown an example in which there are provided 3000 paths that run via the transmission devices B1, B2, A3, A4 and B5 and 7000 paths that run via the transmission devices A1, A2, A3, A4 and A5.

The monitoring control apparatus 40 is connected to all the transmission devices 10 via a control line 31, the communication network 30 and a control line 32. When the monitoring control apparatus 40 acquires information held in the corresponding transmission device 10, the monitoring control apparatus 40 transmits an information acquisition request signal to be transferred to the transmission device 10 through the control line 32, the communication network 30 and the control line 31. The transmission device 10 having received the information acquisition request signal therein stores information corresponding to the request contents therein and transmits an information acquisition response signal to be transferred to the monitoring control apparatus 40 through the control line 31, the communication network 30 and the control line 32.

When the monitoring control apparatus 40 controls the operation of the transmission device 10, the monitoring control apparatus 40 transmits an operation execution request signal to be transferred to the transmission device 10 through the control line 32, the communication network 30 and the control line 31. The transmission device 10 having received the operation execution request signal therein executes an operation corresponding to the request contents thereof and sends an operation execution response signal to be transferred to the monitoring control apparatus 40 through the control line 31, the communication network 30 and the control line 32.

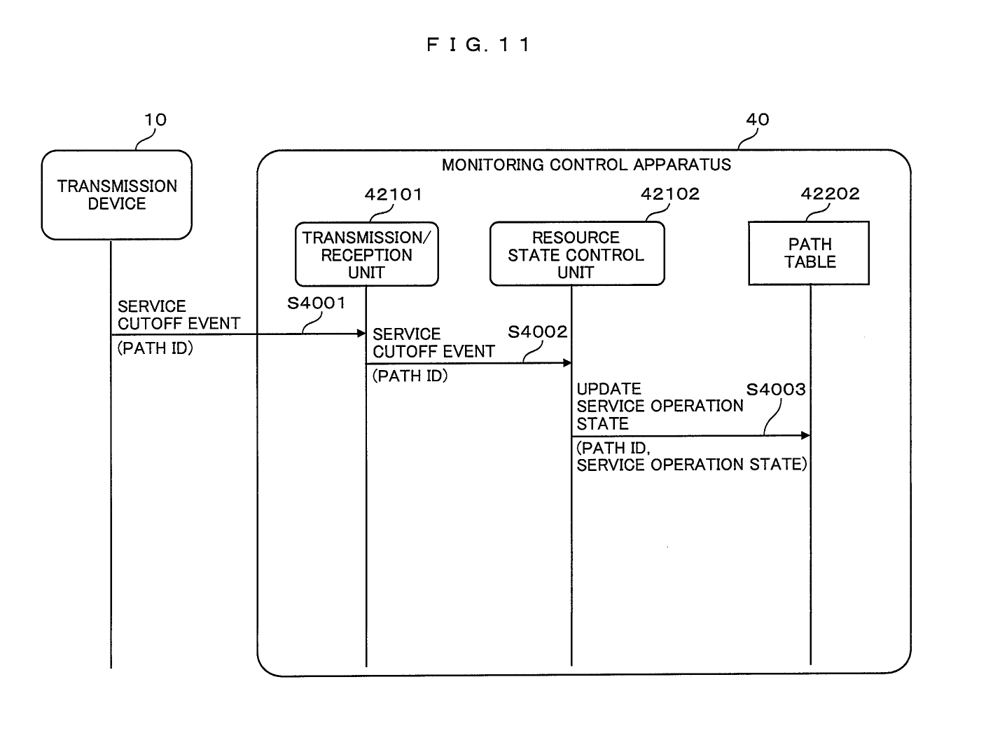

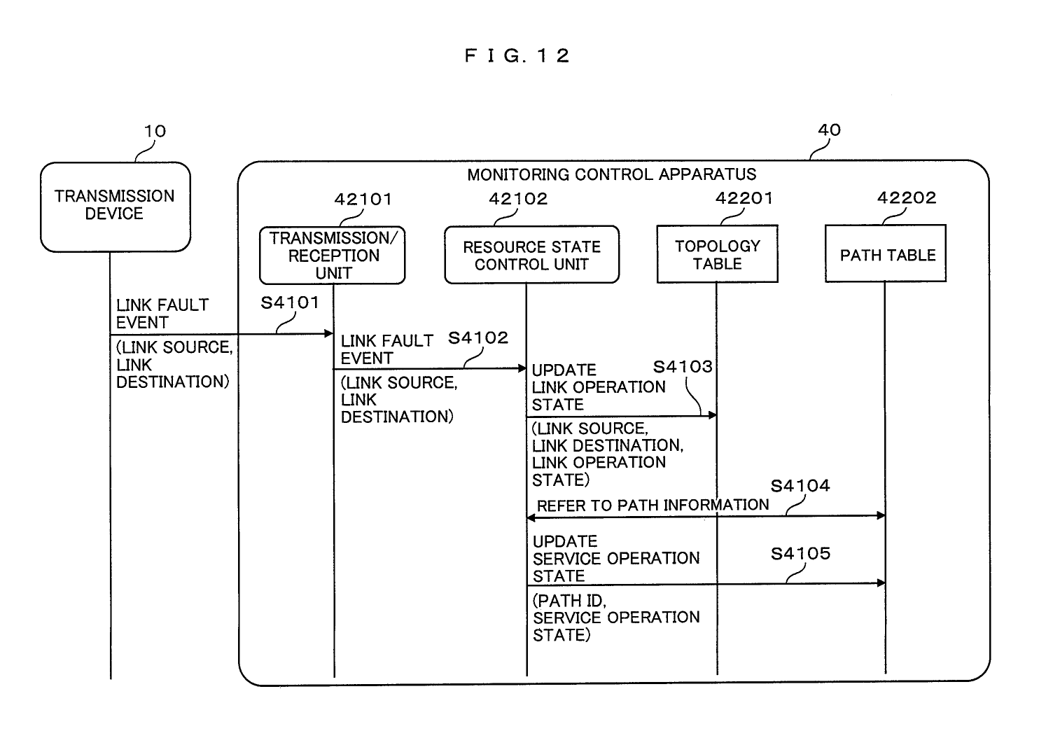

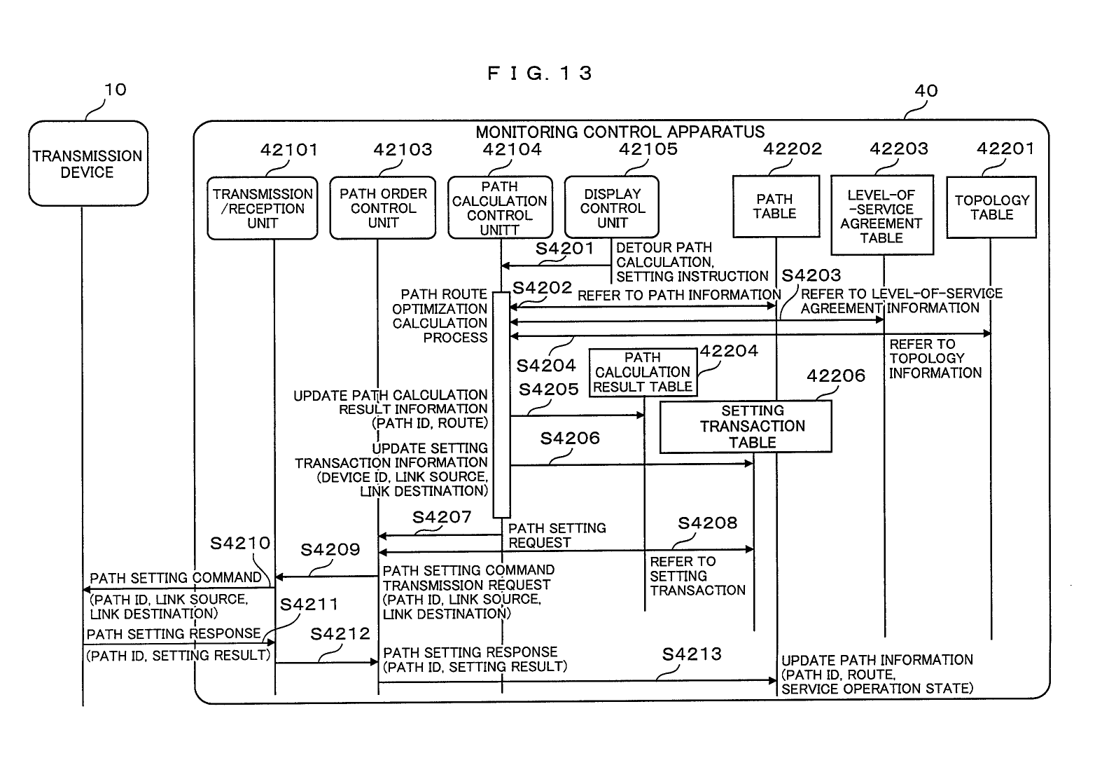

When the transmission device 10 detects a fault or the like, the transmission device 10 sends a state notification signal to be transferred to the monitoring control apparatus 40 through the control line 31, the communication network 30 and the control line 32. The monitoring control apparatus 40 can grasp topology constitution information (transmission devices 10, link 22), path constitution information and a fault state in the entire network by performing mutual transmission of information via all the transmission devices 10 targeted for monitoring, the control line 31, the communication network 30 and the control line 32. The details of a process for updating the topology information and the path constitution information according to the fault state will be described with reference to FIGS. 11 and 12 to be described later. The details of a process sequence for updating the path constitution information according to the calculation and setting of each detour path will be described with reference to FIG. 13 to be described later.

In the present embodiment, when an event in which a major fault such as a serious disaster is assumed has occurred in the system configuration of FIG. 1A, a fault detecting unit and a detour route calculation/setting unit therefor will be explained.

FIG. 1B is a diagram showing a system configuration example of the present invention at the time of fault occurrence. In the present embodiment, assume a case where faults occur in the transmission devices 10 of A2, A3 and A4, the link 22 between the transmission devices A1 and A2, the link 22 between the transmission devices A2 and A3, the link 22 between the transmission devices A3 and A4, the link 22 between the transmission devices A4 and A5, the link 22 between the transmission devices B2 and A3, and the link 22 between the transmission devices A4 and B5.

When the faults in the present example occur, the transmission devices 10 of A1, B2, A5 and B5 transfers a link fault event S4101 through the control line 31, the communication network 30 and the control line 32 to thereby notify the occurrence of a link fault to the monitoring control apparatus 40. The monitoring control apparatus 40 having received the link fault event S4101 therein is capable of analyzing the contents of the received event and grasping in which link 22 between the transmission devices 10 the fault has occurred.

The details of a process sequence in the monitoring control apparatus 40 when the link fault event S4101 is received will be shown in FIG. 11 to be described later.

The transmission devices 10 of A1, B1, A5 and B5 transfer a service cutoff event S4001 through the control line 31, the communication network 30 and the control line 32 to thereby notify the occurrence of a service cutoff to the monitoring control apparatus 40. The monitoring control apparatus 40 having received the service cutoff event S4001 therein is able to analyze the contents of the event and grasp in which path 21 the fault has occurred.

The details of a process sequence in the monitoring control apparatus 40 when it has received the service cutoff event S4001 will be shown in FIG. 12 to be described later. The monitoring control apparatus 40 is able to receive and analyze the link fault event S4101 and the service cutoff event S4001 from the transmission device 10 to thereby grasp the state of faults that has occurred over the network. In the present embodiment, the paths 21 that run via faulty spots include 3000 paths 21 that run via the transmission devices 10 of B1, B2, A3, A4 and B5, and 7000 paths 21 that run via the transmission devices 10 of A1, A2, A3, A4 and A5. It is therefore necessary to calculate and set detour routs for the paths 21 that are 10,000 in total.

### (Route Calculation Method)

### <Situation>

Now, assume a case where the following situations occur in the system configuration in which a plurality of transmission devices (hereinafter abbreviated as devices) are connected by a network as in the present embodiment.

(1-1) Information is transmitted from a given transmission source to another reception source via paths P that run from a given device A to another device B (i.e., the above paths are taken to be some of information transfer routes).

(1-2) A fault has occurred in a partial path P1 between the devices A1 and B1 on the paths P so that information could not be transmitted.

(1-3) At least one partial path Pn exists as a substitute for the path P1. Further, at least one path PN exists as a substitute for the path P. However, Pn is higher than PN in the use priority of the path (i.e., the selection of paths substituted for partial paths in each of which a fault has occurred is given priority).

(1-4) Information (network information) about connection relations between all devices that configure the network are assumed to have been held in advance.

### <Calculation of Route>

(2-1) At least one other partial path Pn to which the partial path P1 between the devices A1 and B1 is connectable is selected based on the network information. If there is a partial path Pn that satisfies a preliminarily given condition X, the partial path Pn is selected from the other partial paths Pn selected.

(2-2) If there is no partial path Pn that satisfies the condition X, at least one alternate path PN that runs from a given device A to the other device B, not including a partial path Pn in which a fault has occurred, is selected. If there is a path PN that satisfies the condition X and a new condition Y (added with the expansion of range of path selection), the path PN is selected from within the alternate paths PN selected.

(2-3) If no path is found in the above (2-2), the range of the device A or/and device B is expanded and the above (2-2) is repeated.

(2-4) When the shortest route or path is selected in the partial paths Pn or the paths PN, there is selected one in which the sum of the numbers of devices included in the corresponding paths or the sum of distances among the devices is smallest.

In the above route calculation method, the range of paths that can be substitute paths is sequentially expanded as well as the paths substituted for the partial paths in which the fault has occurred, and the change of paths is performed while verifying the condition for enabling the paths to be utilized as the substitute paths.

By combining paths that satisfy a part of the above condition X or Y, and other paths that satisfy the remaining part of these conditions, it is also possible to determine a route for avoiding partial paths in which a fault has occurred.

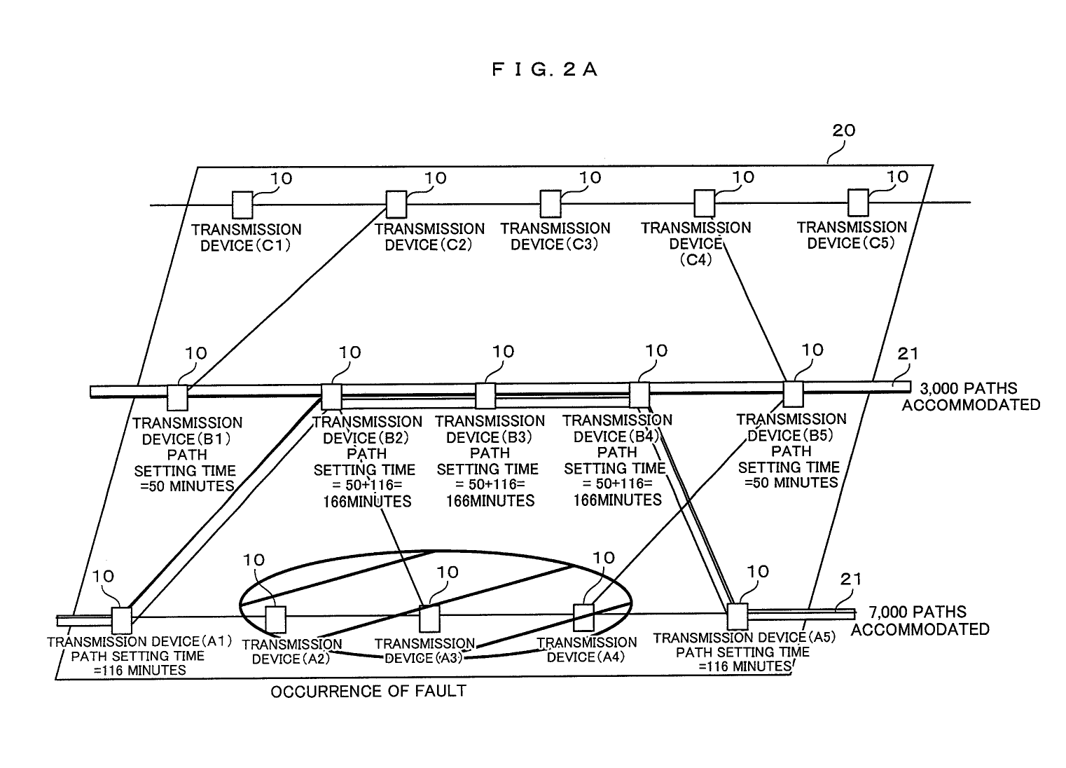

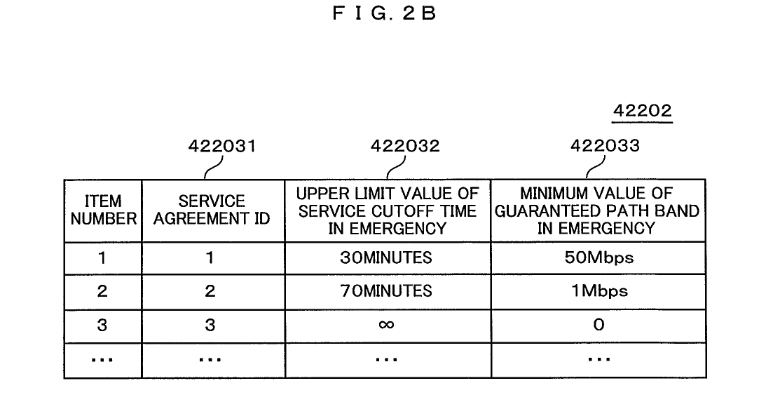

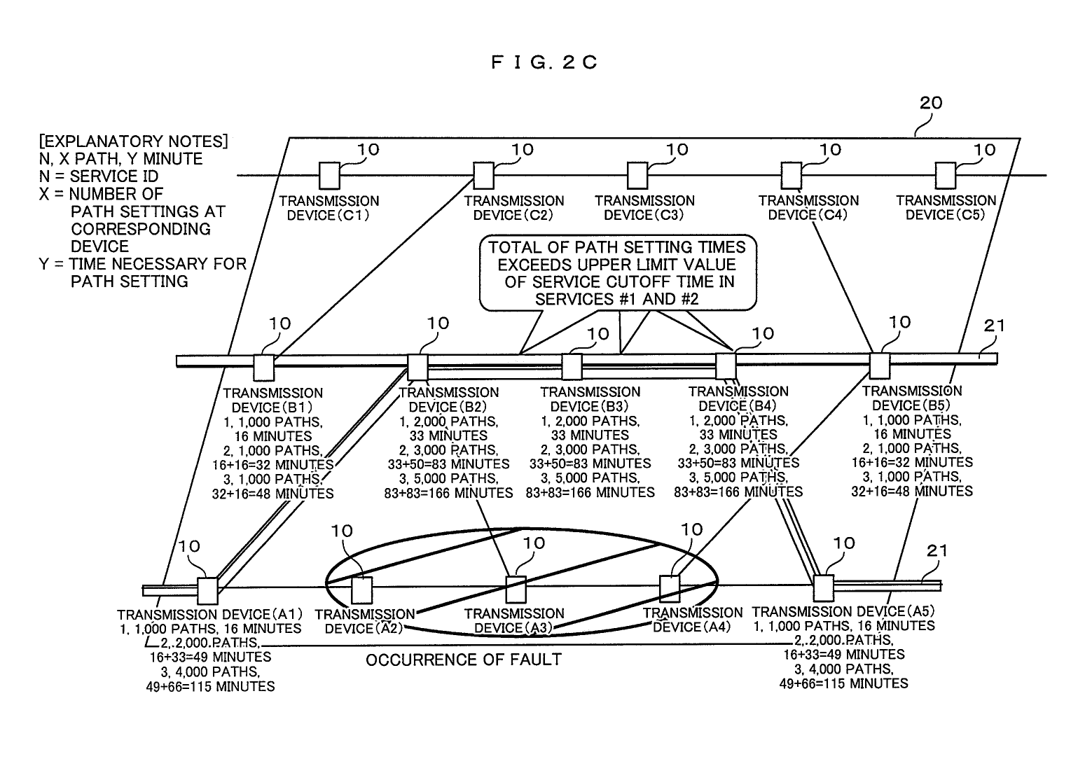

FIG. 2A is a diagram showing a total time required to set a detour route based on the related art and a detour route to each transmission device 10. In the related art, only a route that connects the ends of each path 21 at the shortest route is selected. Thus, in the present embodiment, a route passing through the transmission devices 10 of B1, B2, B3, B4 and B5 is selected as a detour route for the path 21 that runs via the transmission devices 10 of B1, B2, A3, A4 and B5 at normal time, whereas a route passing through the transmission devices 10 of A1, B2, B3, B4 and A5 is selected as a detour route for the path 21 that runs via the transmission devices 10 of A1, A2, A3, A4 and A5.

In order to set one detour route, the monitoring control apparatus 40 issues a path setting command S4210 to each transmission device 10 on the path route. In the case of the detour route passing through each of the transmission devices 10 of B1, B2, B3, B4 and B5, the monitoring control apparatus 40 issues a path setting command S4210 (refer to FIG. 13 to be described later) to each of the transmission devices 10 of B1, B2, B3, B4 and B5.

In the case of the fault in the present example, the number of detour routes that run via the transmission devices 10 of B1, B2, B3, B4 and B5 is 3,000. Therefore, the monitoring control apparatus 40 issues path setting commands S4210 that are 3,000 in total to the transmission devices 10 of B1, B2, B3, B4 and B5. Now, assuming that the path setting processing performance of each transmission device 10 takes one second per path setting command S4210, the time required for the transmission devices 10 to finish processing the path setting commands S4210 that are 3,000 in total becomes 3,000 seconds=50 minutes. Thus, the time required to set the detour route passing through the transmission devices 10 of B1, B2, B3, B4 and B5 takes 50 minutes for the transmission devices 10 thereof. Further, since there exist 7,000 detour routes that run via the transmission devices 10 of A1, B2, B3, B4 and A5, the monitoring control apparatus 40 issues path setting commands S4210 of 7,000 in total to the transmission devices 10 of A1, B2, B3, B4 and A5. Now, likewise, assuming that the path setting processing performance of each transmission device 10 takes one second per path setting command S4210, the time necessary for the transmission devices 10 to finish processing the path setting commands S4210 of 7,000 in total becomes 7,000 seconds=about 116 minutes. Thus, the time required to set the detour route passing through the transmission devices 10 of A1, B2, B3, B4 and A5 takes about 116 minutes for the respective transmission devices 10 of A1, B2, B3, B4 and A5.

Further, the transmission devices 10 of B2, B3 and B4 need to process the path setting commands S4210 for both of the detour route passing through the transmission devices 10 of B1, B2, B3, B4 and B5 and the detour route running via the transmission devices 10 of A1, B2, B3, B4 and A5. The time required to process all the path setting commands S4210 is 50+116=about 166 minutes. Thus, the time required to complete the setting of all detour routes for the 10,000 paths 21 becomes 166 minutes or more for the transmission devices 10 of B2, B3 and B4. That is, it indicates that there is a possibility that since there is no agreement on the service level in emergency in the related art, a service cutoff time of 166 minutes or more will arise in the present embodiment even in the case of the lines requiring emergency. Since they are different in use as described above in the background art, the priority among the lines in emergency should be different from that among lines at normal time. In the present invention, service agreement information shown in FIG. 2B are introduced as differentiation indexes among lines in emergency.

FIG. 2B is a diagram showing service agreement information having defined service levels in emergency. The monitoring control apparatus 40 holds them therein. An item 422032 is an item which defines an upper limit value of a service cutoff time in emergency. An item 422033 is an item which defines the minimum value of a guaranteed path band in emergency.

In the present embodiment, a path to which a service in which the value of a “service agreement ID” item 422031 is 1 is applied defines that the path is recovered within 30 minutes in emergency and its band is 50 Mbps or more. Likewise, a path to which a service in which the value of the “service agreement ID” item 422031 is 2 is applied defines that the path is recovered within 70 minutes in emergency and its band is 1 Mbps or more. Further, a path to which a service in which the value of the “service agreement ID” item 422031 is 3 is applied indicates that since the value of the “upper limit value of the service cutoff time in emergency” item 422032 is set to infinity and the value of “the minimum value of the guaranteed path band in emergency” item 422033 is set to zero, there are no limits on these items. Thus, the service smaller in the upper limit value of the service cutoff time and larger in the minimum value of the path band can be supposed to be applied to the path high in relative emergency among the lines.

FIG. 2C is a diagram showing path setting times relative to each transmission device 10 when taking into consideration only the “upper limit value of the service cutoff time in emergency” item 422032 in FIG. 2B, using the related art upon the path route calculation.

In the present embodiment, there is shown an example in which 1,000 paths 21 to each of which the service in which the value of the “service agreement ID” item 422031 is 1 is applied, 1,000 paths 21 to each of which the service in which the value of the “service agreement ID” item 422031 is 2 is applied, and 1,000 paths 21 to each of which the service in which the value of the “service agreement ID” item 422031 is 3 is applied, are respectively accommodated in the detour route passing through the transmission devices 10 of B1, B2, B3, B4 and B5.

Further, likewise, there is shown an example in which 1,000 paths 21 to each of which the service in which the value of the “service agreement ID” item 422031 is 1 is applied, 2,000 paths 21 to each of which the service in which the value of the “service agreement ID” item 422031 is 2 is applied, and 4,000 paths 21 to each of which the service in which the value of the “service agreement ID” item 422031 is 3 is applied, are respectively accommodated in the detour route that run via the transmission devices 10 of A1, B2, B3, B4 and A5. The transmission devices 10 of B2, B3 and B4 need to process the path setting commands S4210 for both of the detour route passing through the transmission devices 10 of B1, B2, B3, B4 and B5 and the detour route running via the transmission devices 10 of A1, B2, B3, B4 and A5. Further, when distributed according to the “service agreement ID” item 422031, it is necessary to process the path setting commands S4210 with respect to 2,000 paths in which the value of the “service agreement ID” item 422031 is 1, 3,000 paths in which the value of the “service agreement ID” item 422031 is 2, and 5,000 paths in which the value of the “service agreement ID” item 422031 is 3.

Thus, when the path setting process performance of the transmission device 10 is supposed to take one second per path setting command S4210, and the path setting is performed from the service agreement in which the “upper limit value of the service cutoff time in emergency” item 422032 is small in value, the transmission devices 10 of B2, B3 and B4 take the times of 33 minutes taken to finish processing the path setting commands S4210 equivalent to the 2,000 paths in which the value of the “service agreement ID” item 422031 is 1, 33+50=83 minutes taken to finish processing the path setting commands S4210 equivalent to the 3,000 paths in which the value of the “service agreement ID” item 422031 is 2, and 83+83=166 minutes taken to finish processing the path setting commands S4210 equivalent to the 5,000 paths in which the value of the “service item ID” item 422031 is 3.

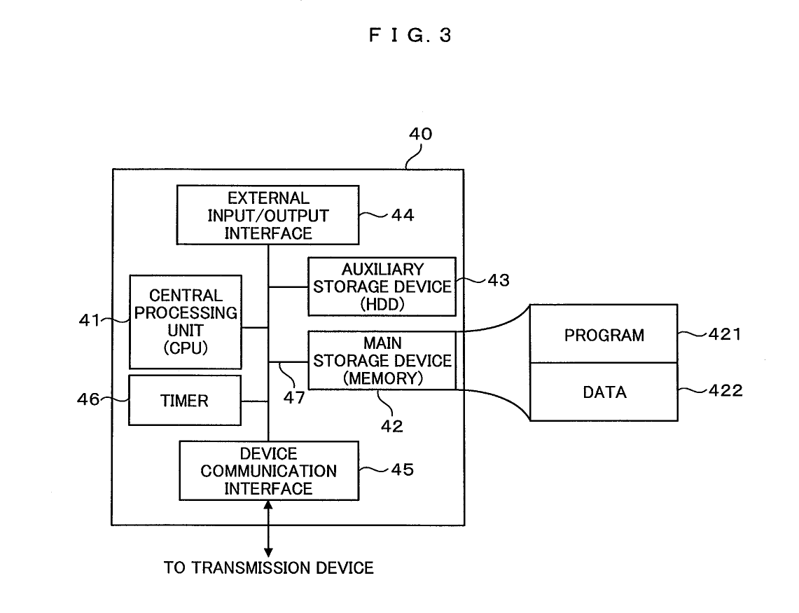

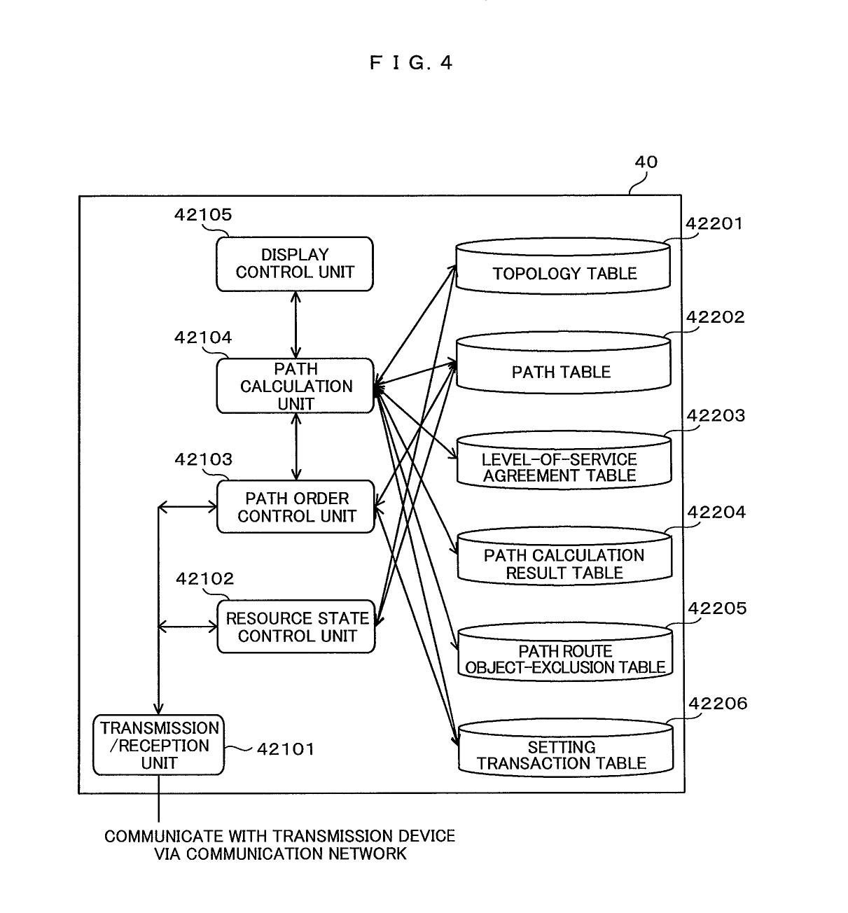

When these times are compared with the “upper limit value of the service cutoff time in emergency” item 422032 in FIG. 2B, the paths beyond the service agreement are found to exist in the paths in each of which the value of the “service agreement ID” item 422031 is 1 and 2. That is, when the path setting is simply done for the routes to which the related art is applied from the “upper limit value of the service cutoff time in emergency” item 422032 small in value, lines that do not satisfy the service agreement occur. It is thus necessary to calculate routes for detour routes having taken into consideration the level of service agreement in emergency. The present invention is made to solve this problem. The hardware and software configurations of the monitoring control apparatus operated in the present invention will first be described with reference to FIGS. 3 and 4 respectively.

### (System Configuration)

FIG. 3 is a diagram showing the hardware configuration of the monitoring control apparatus 40. The monitoring control apparatus 40 is composed of a central processing unit (CPU) 41, a main storage device (memory) 42, an auxiliary storage device (HDD) 43, an external input/output interface 44, a device communication interface 45, a timer 46, and a bus 47. The device communication interface 45 performs transmission/reception of a communication signal to and from each transmission device 10. The external input/output interface 44 inputs signals such as user operation information sent from outside therein. Further, the external input/output interface 44 outputs signals such as display information to a user to the outside. A program 421 and data 422 are stored in the auxiliary storage device (HDD) 43. When the central processing unit (CPU) 41 receives a start instruction for the program 421 therein, the central processing unit 41 expands the program 421 and the data 422 from the auxiliary storage device (HDD) 43 to the main storage device (memory) 42 and performs processing in accordance with an instruction in the program 421. The signals among the devices are transmitted and received via the bus 47. Units according to the present embodiment are mounted in the program 421 and the data 422.

FIG. 4 is a diagram showing the software configuration of the monitoring control apparatus 40. The program 421 shown in FIG. 3 is composed of a transmission/reception unit 42101, a resource state control unit 42102, a path order control unit 42103, a path calculation unit 42104, and a display control unit 42105 as shown in FIG. 4.

The data 422 shown in FIG. 3 is composed of a topology table 42201, a path table 42202, a level-of-service agreement table 42203, a path calculation result table 42204, a path route object-exclusion table 42205, and a setting transaction table 42206.

The transmission/reception unit 42101 performs processing for transmission/reception of information to and from each transmission device 10. The display control unit 42105 processes an operation instruction from the user. The path calculation unit 42104 performs a path route calculation process and a path optimization process using the topology table 42201, the path table 42202, the level-of-service agreement table 42203, the path calculation result table 42204, the path route object-exclusion table 42205, and the setting transaction table 42206. The path order control unit 42103 performs a process for the generation of path setting transaction information using the path table 42202 and the setting transaction table 42206. Further, the path order control unit 42103 performs processing for a transaction execution request and response. The resource state control unit 42102 receives a state change event of the transmission device 10 from the transmission/reception unit 42101 therein and performs state update processing of the topology table 42201 and the path table 42202.

### (Various Information)

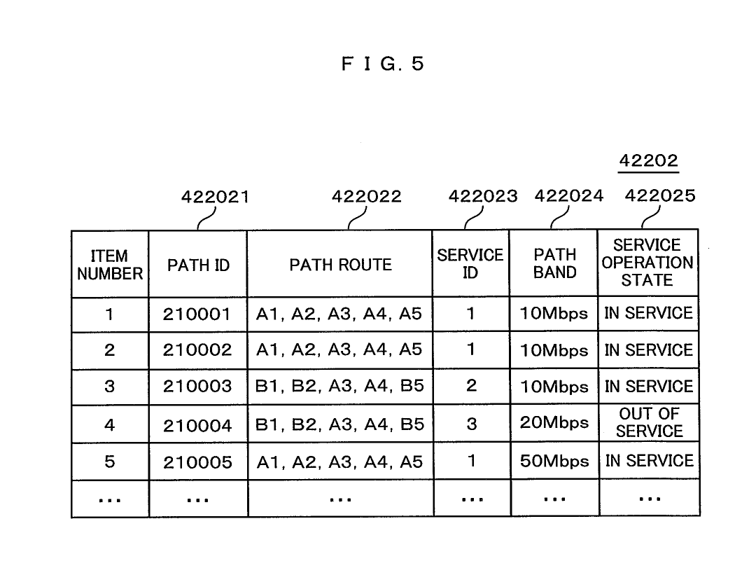

FIG. 5 is a diagram showing the constitution of data transfer path information (path table 42202) of the transmission devices 10, which are held in the monitoring control apparatus 40. The path table 42202 is composed of a “path ID” item 422021, a “path route” item 422022, a “service ID” item 422023, a “path band” item 422024, and a “service operation state” item 422025.

The “path ID” item 422021 is an item which stores an identifier for uniquely specifying path information within the system. The “path route” item 422022 is an item which stores information of the corresponding transmission device 10 through which the corresponding path runs. The “service ID” item 422023 is an item which stores an identifier for service agreement information to which the corresponding path is applied. The “path band” item 422024 is an item which stores resource information that the corresponding path uses for data transfer. The “service operation state” item 422025 is an item which stores information related to the state of service operation of the corresponding path. As its values, there are “being in service” and “being out of service.”

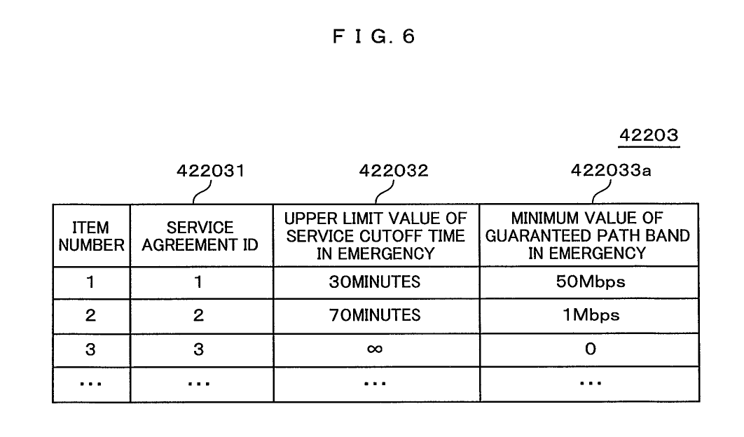

FIG. 6 is a diagram showing the constitution of level-of-service agreement information (level-of-service agreement table 42203) held in the monitoring control apparatus 40. The level-of-service agreement table 42203 is composed of a “service agreement ID” item 422031, an “upper limit value of a service cutoff time in emergency” item 422032, and a “minimum value of a guaranteed path band in emergency” item 422033a.

The “service agreement ID” item 422031 is an item which stores an identifier for uniquely specifying service information within the system. The “upper limit value of the service cutoff time in emergency” item 422032 is an item which defines an upper limit value of a service cutoff time in emergency. The “minimum value of the guaranteed path band in emergency” item 422033a is an item which defines the minimum value of a path band in emergency.

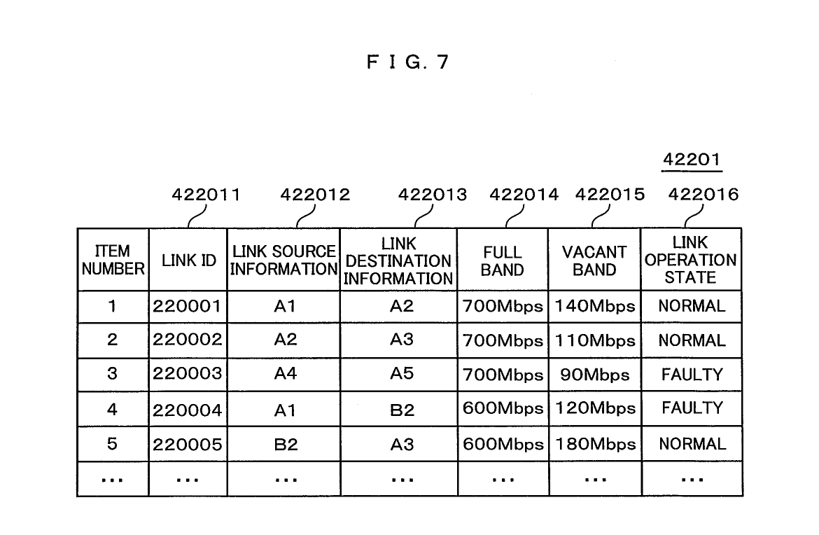

FIG. 7 is a diagram showing the constitution of link information (topology table 42201) of the transmission devices 10, which are held in the monitoring control apparatus 40. The topology table 42201 is composed of a “link ID” item 422011, a “link source information” item 422012 indicative of each transmission device 10 on the transmission side, a “link destination information” item 422013 indicative of each transmission device 10 on the reception side, a “full band” item 422014, a “vacant band” item 422015, and a “link operation state” item 422016.

The “link ID” item 422011 is an item which stores an identifier for uniquely specifying link information within the system. The “link source information” item 422012 is an item which stores information of the transmission device 10 being the start point of the corresponding link. The “link destination information” item 422013 is an item which stores information of the transmission device 10 being the end point of the corresponding link. The “full band” item 422014 is an item which stores the full capacity of the resource of the corresponding link. The “vacant band” item 422015 is an item which stores the vacant capacity of the resource of the corresponding link. The “link operation state” item 422016 is an item which stores information related to the state of operation of the corresponding link. As its values, there are “normal” and “faulty.”

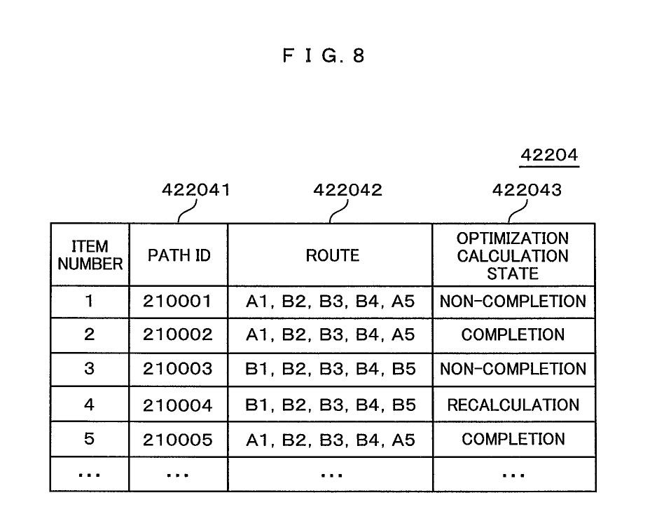

FIG. 8 is a diagram showing the constitution of information (path calculation result table 42204) of path route calculation results held in the monitoring control apparatus 40. The path calculation result table 42204 is composed of a “path ID” item 422041, a “route” item 422042, and an “optimization calculation state” item 422043.

The “path ID” item 422041 is an item which stores an identifier for path information targeted for path calculation. The “route” item 422042 is an item which stores path route information of path calculation results. The “optimization calculation state” item 422043 is an item which stores values indicative of the state of an optimization calculation related to the corresponding path. As its values, there are mentioned “completion,” “non-completion” and “recalculation.”

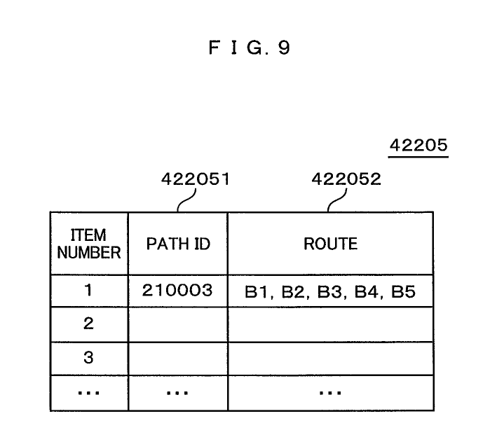

FIG. 9 is a diagram showing the constitution of information (path route object-exclusion table 42205) held in the monitoring control apparatus 40 and excluded from route objects upon path route calculation. When a path is selected, it is registered in this table, which is used to prevent the once selected path from being selected again. The path route object-exclusion table 42205 is composed of a “path ID” item 422051, and a “route” item 422052.

The “path ID” item 422051 is an item which stores an identifier for path information targeted for path calculation. The “route” item 422052 is an item which stores information of path routes excluded from path route objects when the path routes are recalculated.

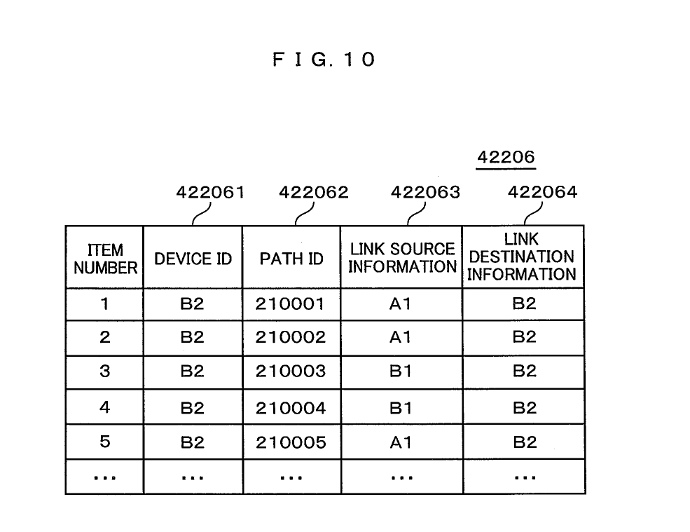

FIG. 10 is a diagram showing the constitution of transaction information (setting transaction table 42206) of path settings held in the monitoring control apparatus 40. The setting transaction table 42206 is composed of a “device ID” item 422061, a “path ID” item 422062, a “link source information” item 422063, and a “link destination information” item 422064.

The “device ID” item 422061 is an item which stores an identifier for each transmission device 10 targeted for path setting. The “path ID” item 422062 is an item which stores an identifier for path information related to the corresponding path setting. The “link source information” item 422063 is an item which stores link information of a data transfer source. The “link destination information” item 422064 is an item which stores link information of a data transfer destination.

### (Processing Contents)

FIG. 11 is a diagram showing a process sequence when the service cutoff event S4001 is notified from the corresponding transmission device 10 to the monitoring control apparatus 40 when a fault occurs. When the transmission device 10 detects a service cutoff, the transmission device 10 sends it to the monitoring control apparatus 40 as the service cutoff event S4001 inclusive of the corresponding path ID information. The monitoring control apparatus 40 receives the service cutoff event S4001 at the transmission/reception unit 42101. The transmission/reception unit 42101 confirms that information necessary for the received event is properly constituted, and transfers a service cutoff event S4002 (same as S4001) to the resource state control unit 42102. The resource state control unit 42102 retrieves path information coincident with a path ID stored in the received service cutoff event S4002 at the path table 42202. When the corresponding path information exists as a result of its retrieval, the resource state control unit 42102 updates the value of the “service operation state” item 422025 of the corresponding path to the “being out of service” at the path table 42202.

FIG. 12 is a diagram showing a process sequence when a link fault event S4101 is notified from the corresponding transmission device 10 to the monitoring control apparatus 40 at the occurrence of a fault. When the transmission device 10 detects a link fault, the transmission device 10 sends it to the monitoring control apparatus 40 as the link fault event S4101 inclusive of the corresponding link information. The monitoring control apparatus 40 receives the link fault event S4101 at the transmission/reception unit 42101. The transmission/reception unit 42101 confirms that information necessary for the received event is properly constituted, and transfers a link fault event S4102 (same as S4101) to the resource state control unit 42102.

The resource state control unit 42102 retrieves link information coincident with the link source information and link destination information stored in the received link fault event S4102 at the topology table 42201. When the corresponding link information exists as a result of its retrieval, the resource state control unit 42102 updates the value of the “link operation state” item 422016 of the corresponding link information to the “faulty” at the topology table 42201 (S4103).

Further, the resource state control unit 42102 retrieves path information having the link source information and link destination information stored in the received link fault event S4102, which are included in the “path route” item 422022 at the path table 42202 (S4104). When the corresponding path information exists as a result of its retrieval, the resource state control unit 42102 updates the value of the “service operation state” item 422025 of all the corresponding path information to the “being out of service” at the path table 42202 (S4105). The monitoring control apparatus 40 is able to grasp the situation of a fault being generated over the network by the process sequence for notifying the service cutoff from the transmission device 10 in FIG. 11, and the process sequence for notifying the link fault from the transmission device 10 in FIG. 12. Then, on the basis of the gasped fault situation over the network, the monitoring control apparatus 40 executes the calculation and optimization of a detour path based on the service agreement in emergency to perform path setting processing.

FIG. 13 is a diagram showing a process sequence for performing the calculation, optimization and setting of a detour path by the monitoring control apparatus 40. A maintenance person performs the calculation and setting operation of the detour path at the display control unit 42105. The display control unit 42105 designates the path calculation control unit 42104 to perform a detour path calculation and a setting instruction S4201.

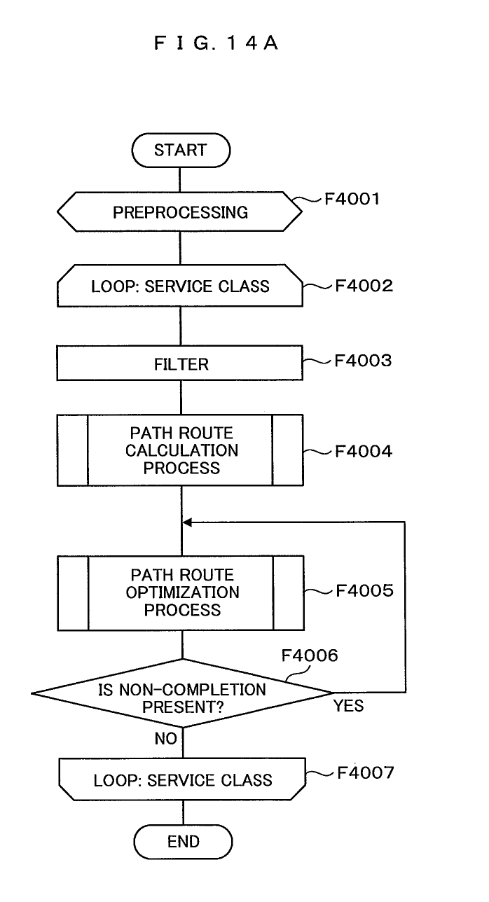

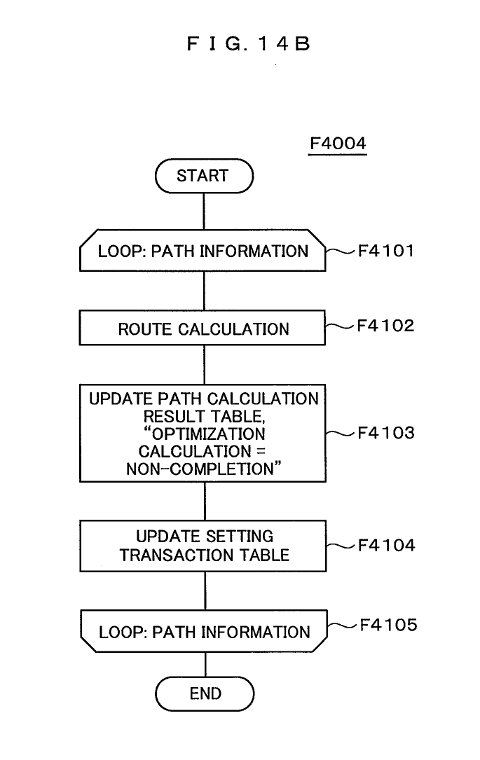

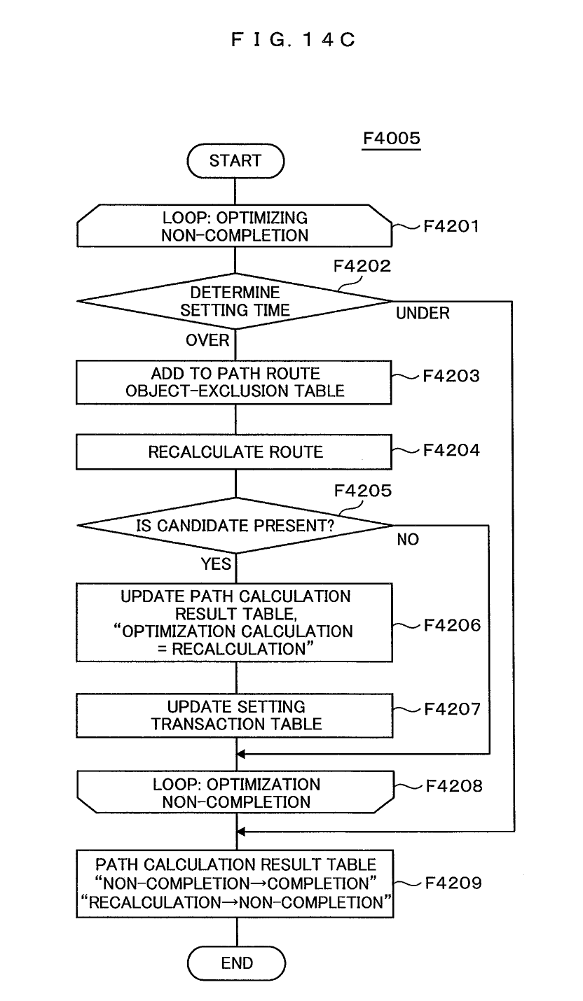

The path calculation control unit 42104 performs the calculation and optimization of a detour path with reference to the path table 42202, the level-of-service agreement table 42203 and the topology table 42201 like S4202, S4203 and S4204. The detail processing of the calculation and optimization of the detour path is shown in FIGS. 14A, 14B and 14C.

Upon the calculation of the detour path and the optimization thereof, the path calculation control unit 42104 updates the path calculation result table 42204 and the setting transaction table 42206 like S4205 and S4206. A longitudinal block connected to the path calculation control unit 42104 in FIG. 13 represents a path route optimization calculation process. The path calculation control unit 42104 performs a path setting request S4207 on the path order control unit 42103, based on the table 42206.

The path order control unit 42103 refers to the setting transaction table 42206 like S4208 and performs a path setting command transmission request S4209 to the transmission/reception unit 42101.

The transmission/reception unit 42101 generates a path setting command and transmits the corresponding command to the corresponding transmission device 10 as S4210.

The transmission device 10 executes path control in accordance with the contents of the path setting command and sends an execution result thereof to the monitoring control apparatus 40 as a path setting response S4211.

The transmission/reception unit 42101 confirms that information necessary for the received response is properly constituted, and transfers a path setting response S4212 to the path order control unit 42103. The path order control unit 42103 determines that all path settings on the corresponding path route have been normally completed, and updates the value of the “service operation state” item 422025 of the corresponding path to the “being in service” as S4213 at the path table 42202.

FIG. 14A is a diagram showing a processing flow of a route calculation of a detour path and its optimization calculation in the monitoring control apparatus 40. The processing of FIG. 14A is the details of the path route optimization calculation process indicated by the longitudinal block connected to the path calculation control unit 42104 of FIG. 13.

Processing F4001: refer to the following information. (preprocessing)

(1) Path information in which the value of the “service operation state” item 422025 of the path table 42202 shown in FIG. 5 is “being out of service,”
(2) Link information of the topology table 42201 shown in FIGS. 7, and
(3) Service agreement information of the level-of-service agreement table 42203 shown in FIG. 6.

Processing F4002: start repeat processing corresponding to each entry of the level-of-service agreement table 42203. A loop order is started from the small value of the “upper limit value of the service cutoff time in emergency” item 422032.

Processing F4003: the path information acquired above is filtered with a level-of-service agreement entry in a loop.

Processing F4004: perform a path route calculation process. The details thereof are described in FIG. 14B.

Processing F4005: perform an optimization process of a path route. The details thereof are described in FIG. 14C.

Processing F4006: if there exists path route calculation information in which the value of the “optimization calculation state” item 422043 in the path calculation result table 42204 shown in FIG. 8 is “non-completion,” it is shifted to the processing F4005.

Processing F4007: if a loop corresponding to all entries of the level-of-service agreement table 42203 is completed, the repeat processing is ended.

FIG. 14B is a diagram showing a processing flow of the path route calculation (F4004) in the monitoring control apparatus 40.

Processing F4101: start repeat processing corresponding to an entry of path information indicative of a result of execution of the filter processing at the preprocessing.

Processing F4102: perform a path route calculation. The conditions for the calculation are as follows:

(1) Shortest route, and
(2) Band greater than or equal to the value of the “minimum value of the guaranteed path band in emergency” item 422033 of the level-of-service agreement information in the loop.

That is, the path at the shortest route having a band larger than the minimum value of the path band in emergency is determined.

Processing F4103: update the path calculation result table 42204 using the calculated route information. The “optimization calculation state” item 422043 of the corresponding information is changed to “non-completion.” When there is no detour path candidate, the “optimization calculation state” item 422043 of the corresponding information is changed to “completion.”

Processing F4104: generate setting transaction information for every transmission device 10 with respect to the route information calculated above and update the setting transaction table 42206 of FIG. 10.

Processing F4105: if a loop corresponding to all path information entries is completed, the repeat processing is ended.

FIG. 14C is a diagram showing a processing flow of the path route optimization process (F4005) in the monitoring control apparatus 40.

Processing F4201: start repeat processing corresponding to the path calculation result information in which the value of the “optimization calculation state” item 422043 is “non-completion,” at the path calculation result table 42204 shown in FIG. 8.

Processing F4202: calculate the total value of setting times to the individual transmission devices 10 from the setting performance parameters of the transmission devices 10 on the basis of setting transaction information in which the value of the “optimization calculation state” item 422043 is other than the “recalculation,” at the path calculation result table 42204. In the present embodiment, the setting performance of each transmission device 10 is taken to be uniformly 1 [second/transaction/transmission device].

Each setting time calculated and the “upper limit value of the service cutoff time in emergency” item 422032 of the service agreement information in the loop are compared with each other. When the setting times for all the transmission devices 10 fall below the upper limit value of the service cutoff time, the processing flow is shifted to a processing F4209. When any one of them exceeds the upper limit value, the processing flow proceeds to the processing F4203.

Processing F4203: add the value of the “route” item 422042 of the path calculation result information to the “route” item 422052 of the corresponding path ID at the path route object-exclusion table 42205.

Processing F4204: perform recalculation of a path's route. The conditions for the calculation are as follows:

(1) Shortest route,
(2) Band greater than or equal to the value of the “minimum value of the guaranteed path band in emergency” item 422033 of the level-of-service agreement information in the loop, and
(3) Take the “route” item 422052 of the corresponding path ID of the path route object-exclusion table 42205 shown in FIG. 9 not to be a candidate.

That is, the path which is at the shortest route having a band larger than the minimum value of the guaranteed path band in emergency and is not yet selected as a path route is determined.

Processing F4205: confirm whether there is a route that meets the condition, as a result of the path route calculation. When a candidate for the path route is found, the processing flow is shifted to a processing F4206. If not, the processing flow proceeds to a processing F4208.

Processing F4206: update the path calculation result table 42205 using the calculated route information. The value of the “optimization calculation state” item 422043 of the corresponding information is changed to “recalculation.”

Processing F4207: generate setting transaction information for every transmission device 10 with respect to the route information calculated above and update the setting transaction table 42206.

Processing F4208: if a loop corresponding to each entry of path calculation result information placed in optimization non-completion is completed, the repeat processing is ended.

Processing F4209: at the path calculation result table 42204, the value of the “optimization calculation state” item 422043 to be taken as “non-completion” is changed to “completion,” and the value thereof taken to be as “recalculation” is changed to “non-completion.”

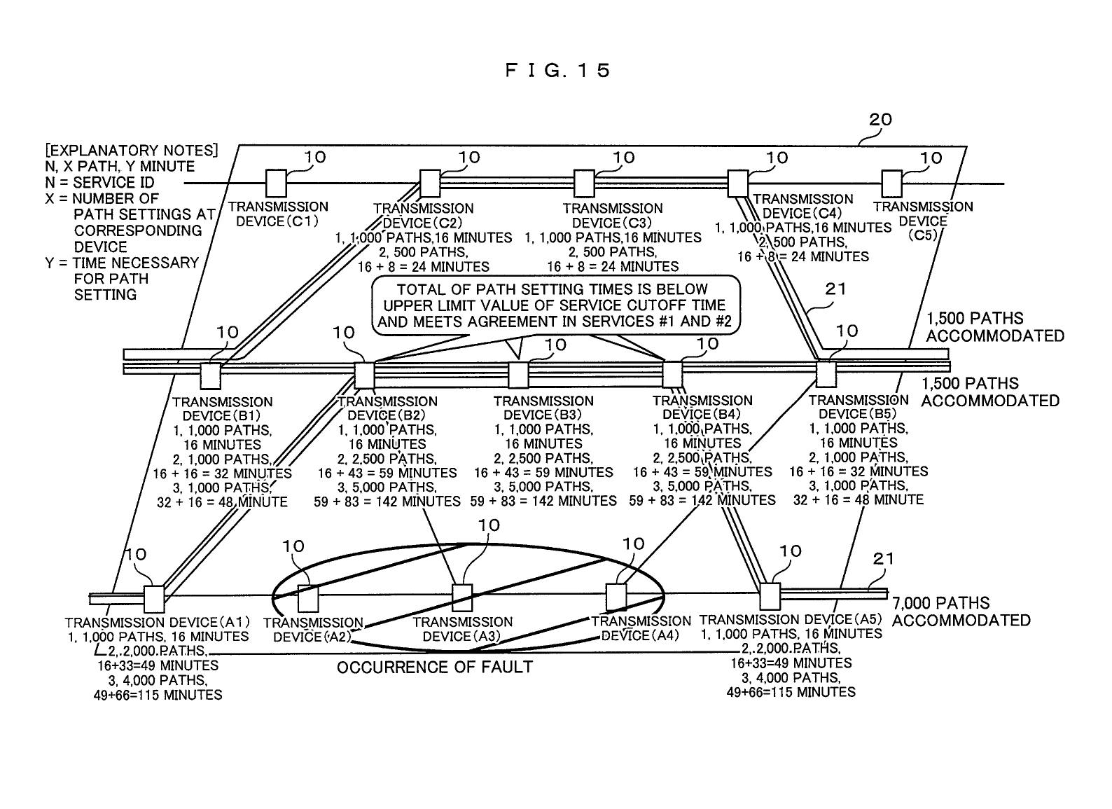

FIG. 15 is a diagram showing the sum of setting times necessary for detour paths and each transmission device used as a result obtained by calculating the detour paths having considered the level of service agreement in emergency according to the present invention. In the present embodiment, in the transmission device B2, 16 minutes taken for 2,000 paths in which the value of the “service agreement ID” item 422031 is 1, 59 minutes taken for 3,000 paths in which the value of the “service agreement ID” item 422031 is 2, and 142 minutes taken for 5,000 paths in which the value of the “service agreement ID” item 422031 is 3 respectively represent times required to complete path settings. When these times are compared with the “upper limit value of the service cutoff time in emergency” item 422032 in FIG. 2B, it is found that the values thereof fall below it in all service agreements and meet requirements.

As compared with the case of FIG. 2A before the implementation of the present embodiment, it is found that there are provided paths that run via five transmission devices (A1, B2, B3, B4 and A5) to avoid three transmission devices (A2, A3 and A4) in which a fault has occurred, and in order to allow the total of path setting times to fall below the upper limit of the service cutoff time and satisfy the service agreement in services #1 and #2 by means of the paths, there are further provided new paths that run via five transmission devices (B1, C2, C3, C4 and B5), whereby the values related to the “upper limit value of the service cutoff time in emergency” are set below and meet requirements in all service agreements.

What is claimed is:

1. A detour path calculation method in emergency suitable for use in a monitoring control apparatus that monitors a communication network connecting a plurality of transmission devices to each other by data transfer links, said detour path calculation method comprising the steps of:
storing in a storage device of the monitoring control apparatus, a path table for holding path information related to at least one path being each route for the data transfer links to which user data is transferred, a topology table for holding connection relations among the transmission devices, and a level-of-service agreement table defining service levels in emergency;
determining a path in which a communication fault has occurred, based on the path table;
sequentially extracting the service levels small in terms of an upper limit value of a service cutoff time in emergency from the level-of-service agreement table;
performing a path route calculation process on at least one path coincident with each of the extracted service levels, based on the path table;
performing a path route optimization process on said at least one path route subjected to the route calculation; and
registering a result of execution of the path route optimization process in a path calculation result table.

2. The detour path calculation method according to claim 1,
wherein the path route calculation process calculates paths at a shortest route having a band larger than a minimum value of a path band in emergency, based on the topology table and the level-of-service agreement table,
sets “non-completion” to an optimization calculation state of the path calculation result table, based on information of the calculated route if a detour path candidate exists in the paths at the shortest route, and sets “completion” to the optimization calculation state based on the calculated route information if the detour path candidate is absent, and
generates setting transaction information for every said transmission device with respect to the calculated route information and updates a setting transaction table defining connection relations between the two transmission devices.

3. The detour path calculation method according to claim 2,
wherein the path route optimization process extracts path result calculation information in which the optimization calculation state of the path calculation result table is “non-completion,”
calculates the total value of setting times to the individual transmission devices from predetermined setting performance parameters of the transmission devices on the basis of setting transaction information other than the value of the optimization calculation state of the path calculation result table being “recalculation,”
compares the calculated setting times and the upper limit value of the service cutoff time in emergency, of service agreement information in a loop and updates the path calculation result table when the setting times for all said transmission devices fall below the upper limit value of the service cutoff time,
adds the value of each route in path calculation result information to a path route object-exclusion table when the setting times for the transmission devices exceed the upper limit value of the service cutoff time,
performs recalculation of a path route by determining a path which is at a shortest route having a band larger than a minimum value of a guaranteed path band in emergency and is not yet selected as a path route,
updates the value of the optimization calculation state of the path calculation result table to “recalculation,” based on the calculated route information when a route meeting a condition is found as a result of the recalculation of the path route, and further generates setting transaction information for every said transmission device with respect to the calculated route information to thereby update the setting transaction table,
updates the value of the optimization calculation state of the path calculation result table to “optimization non-completion” when a path candidate meeting a condition is not found as a result of the recalculation of the path route,
terminates repeat processing when a loop corresponding to an entry of path calculation result information of the optimization non-completion is completed, and
changes the value of the optimization calculation state of the path calculation result table from “non-completion” to “completion” and changes the value of the optimization calculation state thereof from “recalculation” to “non-completion.”

4. A monitoring control apparatus that monitors a communication network connecting a plurality of transmission devices to each other by data transfer links, said monitoring control apparatus comprising
a control unit determining a setting schedule including path routes, periods and order in such a manner that in emergency when a fault occurs in the communication network, the recovery of each line high in resource securing priority is performed preferentially and the number of lines meeting an in-emergency level of service agreement is more increased.

5. The monitoring control apparatus according to claim 4, wherein the in-emergency level of service agreement includes an upper limit value of a service cutoff time, and line quality including at least a minimum value of a guaranteed band and upper limit values of latency/jitter/packet loss rate.

6. The monitoring control apparatus according to claim 5, wherein the control unit further includes a section determining a setting schedule in such a manner that a total value of service cutoff times is more reduced.

7. A detour path calculation method in emergency suitable for use in a network system in which a plurality of transmission devices are connected by a communication network, said detour path calculation method comprising the steps of:
transmitting information from a given transmission source to the other reception source via a path P from a given device A to another device B and holding in advance network information indicating connection relations among all the devices configuring the network, said network information including at least one partial path Pn existing therein substituted for a path P1, and at least one path PN existing therein higher than Pn in path use priority and substituted for the path P;
when a fault occurs in the partial path P1 between devices A1 and B1 on the path P to disable transmission of information,
selecting, based on the network information, at least one other partial path Pn to which the partial path P1 between the devices A1 and B1 is connectable, and selecting a partial path Pn meeting a preliminarily given condition X from within other partial paths Pn selected, if the partial path Pn exists therein;
selecting, if there is no partial path Pn meeting the condition X, at least one alternate path PN running from a given device A to the other device B, not including a partial path Pn with a fault generated therein, based on the network information, and selecting from within the alternate paths PN selected, a path PN meeting the condition X and a new condition Y added with the expansion of a range of a path selection if the path PN exists;
expanding the range of the device A or/and device B if no path is found in said step, and repeating said step; and
selecting, when a shortest route is selected in the partial paths Pn or the paths PN, a shortest route in which the sum of the numbers of the devices included in the corresponding paths or the sum of distances among the devices is smallest.

8. The detour path calculation method in emergency according to claim 7, further comprising the step of
sequentially expanding a range of paths that can be substitute paths as well as the paths substituted for the partial paths in each of which the fault has occurred, and performing the change of paths while verifying a condition for enabling the paths to be utilized as the substitute paths.

9. The detour path calculation method according to claim 7, wherein a route for avoiding partial paths in each of which a fault has occurred is determined by combining paths that satisfy a part of the condition X or Y, and other paths that satisfy the remaining part of these conditions.
